(19) United States
(12) Patent Application Publication
(10) Pub. No.: US 2010/0300147 A1
(43) Pub. Date: Dec. 2, 2010

(54) BRACELET WITH MESSAGE CLIPS

(76) Inventors: Tasha J. Farmer, Holland, MI (US); David E. Farmer, Holland, MI (US)

Correspondence Address: FRASER CLEMENS MARTIN & MILLER LLC, 28366 KENSINGTON LANE, PERRYSBURG, OH, 43551, US

(21) Appl. No.: 12/825,988

(22) Filed: Jun. 29, 2010

Related U.S. Application Data
(63) Continuation-in-part of application No. 12/187,523, filed on Aug. 7, 2008.

(51) Int. Cl. A44C 5/18; G09F 3/10

(52) U.S. Cl. 63/3.1; 40/638

(57) ABSTRACT

A bracelet for displaying messages includes a continuous elastic band and at least one releasably attached message clip. The message clip has a body with a front surface and a rear surface with a flange extending about a periphery of the front surface forming a recessed area. A clip portion is connected to the body for releasably holding the body on the band. A message portion having a display surface with a message displayed thereon is mounted on the body and received in the recessed area wherein the message is visible.

### CROSS-REFERENCE TO RELATED APPLICATION

This application is a continuation-in-part of the co-pending U.S. patent application Ser. No. 12/187,523 filed Aug. 7, 2008.

### BACKGROUND OF THE INVENTION

The present invention relates generally to an apparatus for displaying messages and, in particular, to a bracelet with removable clips displaying messaging for wearing on a wrist.

### SUMMARY OF THE INVENTION

A clip carrying a message is used to accessorize wearing apparel such as hats, clothes, book bags, bracelets, pants, etc. The clip gives people the opportunity to express themselves with a wide variety of messaging.

The message clip is formed from a body having a message portion attached to a front surface and a clip portion for attachment. The clip portion can be formed integral with the body, or can be a separate part attached to a rear surface of the body.

The message clip comprises: a body having a front surface and a rear surface with a flange extending about a periphery of the front surface forming a recessed area; a clip portion connected to the rear surface for releasably holding the body on an item; and a message portion having a display surface with a message displayed thereon, the message portion being mounted on the body and received in the recessed area wherein the message is visible.

The message clip can be removably attached to a continuous band of flexible, elastic material to provide a bracelet for displaying messages. The bracelet comprises: the continuous band of flexible, elastic material for wearing on a wrist of a user, the band having a predetermined thickness and a predetermined width; at least one message clip body with a front surface, a rear surface and a flange extending about a periphery of the front surface forming a recessed area; a clip portion connected to the body for releasably holding the body on the band with the band retained between the clip portion and the rear surface of the body; and a message portion having a display surface with a message displayed thereon, the message portion being mounted on the body and received in the recessed area wherein the message is visible. When the message clip is attached, the band is slightly compressed between the message clip body and the clip portion.

### DESCRIPTION OF THE DRAWINGS

The above advantages, as well as other advantages of the invention, will become readily apparent to those skilled in the art from the following detailed description of a preferred embodiment when considered in the light of the accompanying drawings in which:

FIG. 1 is a front elevation view of a message clip in accordance with the invention;

FIG. 2 is side elevation view of the message clip shown in FIG. 1;

FIG. 3 is an enlarged partial cross-sectional view of an alternate embodiment the body and message portion of the message clip shown in FIGS. 1 and 2;

FIG. 4 is a partial side elevation view of a second alternate embodiment of the body and the clip portion of the message clip shown in FIGS. 1 and 2;

FIG. 5 is an enlarged partial cross-sectional view of a third alternate embodiment of the body and the clip portion of the message clip shown in FIGS. 1 and 2;

FIG. 6 is a block diagram of a circuit for providing the message clip with light and sound according to the invention;

FIG. 7 is a front elevation view of a fourth alternate embodiment message clip in accordance with the invention;

FIG. 8 is side elevation view of the message clip shown in FIG. 1;

FIG. 9 is a fragmentary rear elevation view of the free end of the clip portion of the message clip shown in FIG. 7;

FIG. 10 is a perspective view of the message clip shown in FIG. 1 attached to a bracelet in accordance with the invention; and

FIG. 11 is a fragmentary bottom elevation view of the message clip and bracelet shown in FIG. 10.

### DESCRIPTION OF THE PREFERRED EMBODIMENT

The message clip according to the invention is a distinctive product to accessorize hats, other articles of clothing, book bags, bracelets, etc. The unique design makes it easy to apply quickly to an assortment of things, The message clip gives people the opportunity to express themselves with a wide variety of messaging. The message clip can be removably attached to a band to be worn on the wrist of a user as a message displaying bracelet.

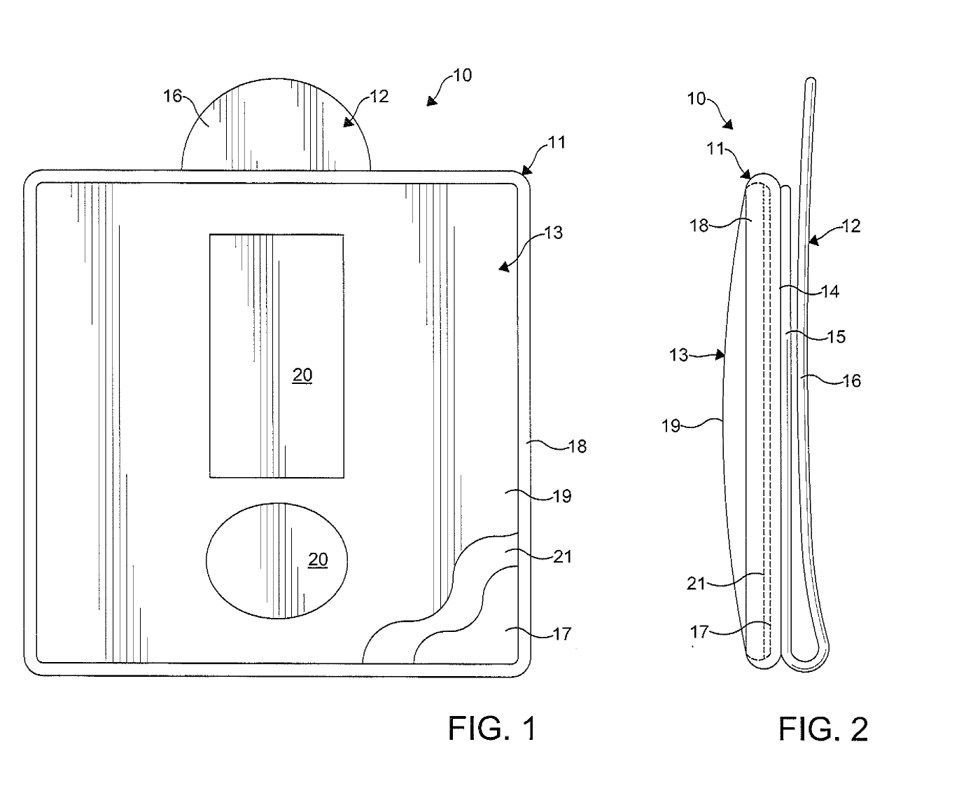

The message clip can be made of spring steel, brass, plastic, precious metals, or other suitable material, in a shape similar to a basic money clip. As shown in FIGS. 1 and 2, a message clip 10 has a body 11 with a clip portion 12 attached to one side and a message portion 13 attached to an opposite side. The body 11 has a generally planar rear surface 14 to which the generally U-shaped clip portion 12 is attached at a generally straight leg 15 thereof. The clip portion 12 can be attached to the surface 14 by a fastening means in any suitable manner such as by welding or with an adhesive material. The clip portion 12 is formed from a resilient material so that a free leg 16 can be bent away from the attached leg 15 to insert an item therebetween such as one or more layers of cloth at an edge of a cap, shirt pocket, pants belt loop, etc. When released, the free leg 16 will spring back toward the attached leg 15 to firmly and releasably hold the message clip 10 on the item.

The body 11 has a front surface 17 at which the message portion 13 is mounted. The front surface 17 is surrounded at a periphery by an outwardly extending flange 18 to form a recessed area such that the message portion 13 is partially recessed (FIG. 2). An outwardly facing display surface 19 of the message portion 13 has a visible message applied thereto. As shown in FIG. 1, the message is an exclamation mark 20, but can be any symbol, logo, words, picture, etc. The display surface 19 can be flat or curved (as shown), and the message can be raised from and/or recessed into the surface 19. The message portion 13 can be attached to the front surface 17 by a fastening device 21 in any suitable manner such as by welding, or with an adhesive material, or by a mechanical fastener. For example, the fastening device 21 is shown in the form of a layer of adhesive material or a double-sided adhesive sheet. In a preferred embodiment, the body 11, the clip portion and the message portion are formed from etched brass and the message 20 is offset printed on the display surface.

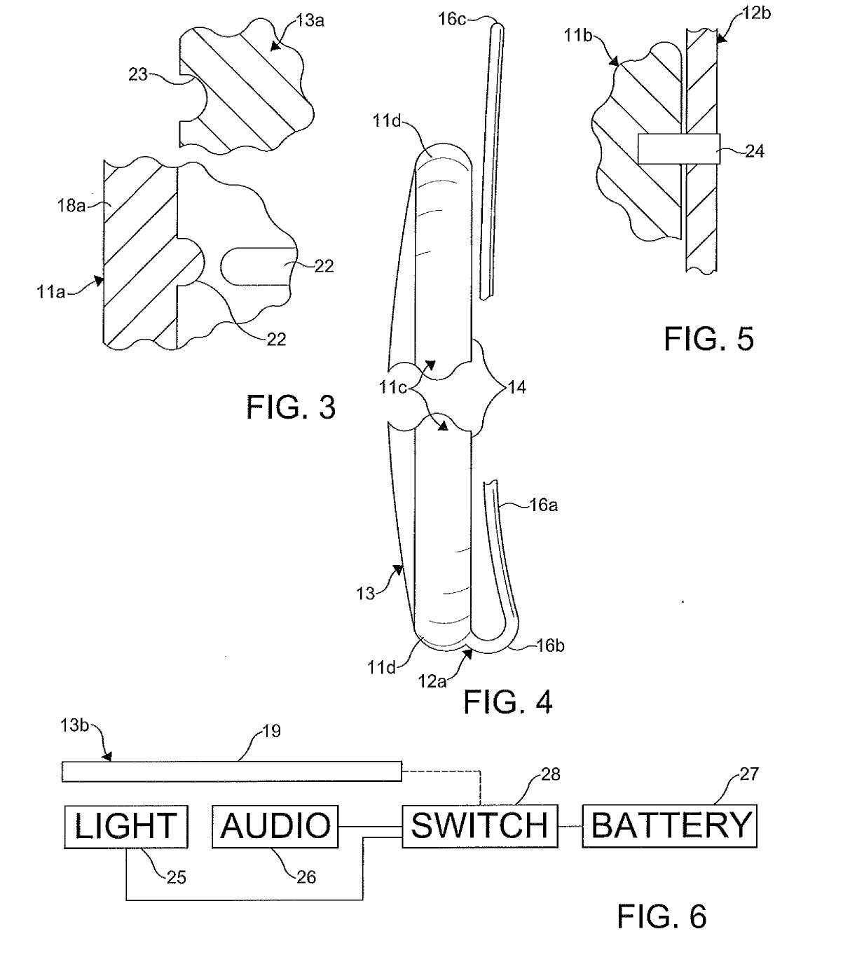

Other fastening devices can be used to attach the message portion to the body. As shown in FIG. 3, an alternate embodiment body 11a can have a projections 22 formed on an inner surface of a flange 18a. The projections 22 can be of any suitable shape and cooperate with a depression or groove 23 formed in a side of an alternate embodiment message portion 13a.

The message portion 13 can be permanently fixed relative to the clip portion 12, as well as be variably fixed, which allows the user to “turn” the display surface 19 to the desired angle. In some cases, the attachment of the message clip 10 to an item may require reorientation of the message 20 for proper viewing. For example, if the message clip 10 shown in FIG. 1 is rotated 90°, it may be difficult to recognize the message 20 as an exclamation mark. As shown in FIG. 5, an alternate embodiment body 11b can be attached to a clip potion 12b by a rotation device such as a pivot pin 24 that permits rotation of the body 11b relative to the clip portion 12b.

As shown in FIG. 4, a message clip body 11c, similar to any of the bodies 11, 11a, 11b, can have a clip portion 12a formed integral therewith such that the body 11c and the clip portion 12a are a one-piece unit. A leg 16a, similar to the leg 16, extends generally parallel to and is spaced from the rear surface 14. The leg 16a has one end 16b that is U-shaped and connects to a peripheral surface lid of the body 11c. An opposite free end 16c of the leg 16a extends away from the body 11c at the peripheral surface 11d. Similar to the message clip 10 shown in FIGS. 1 and 2, the free end 16c of the leg 16a is positioned at an upper portion of the message 20 when the message clip is oriented for viewing.

The message clip 10 also can be provided with the capability to light up and/or play sounds. As shown in FIG. 6, a light 25 and an audio player 26, for playing stored music, words, miscellaneous sounds, etc., are connected to a source of power such as a battery 27 by a switch 28. The light 25, the audio player 26, the battery 27 and the switch 28 can be located in the recess formed in the body 11 by the front surface 17 and the flange 18. A message portion 13b is used to selectively actuate the switch 28 by mechanical action, or preferably by sensing contact of a human finger on the display surface 19. Although only the one switch 28 is shown, separate switches could be provided for the light 25 and the audio player 26.

The message clip 10 can come in a variety of shapes and sizes to compliment the message 20 being displayed. For example, the body 11 and the message portion 13 can be circular. This would permit the message portion 13 to be rotatably attached to the body 11 by the pivot pin 24.

The message 20 can be proprietary and non-proprietary verbiage, slogans, sayings, taglines, company names, brand names, logos, icons, licensed materials, and imagery to express any messages desired.

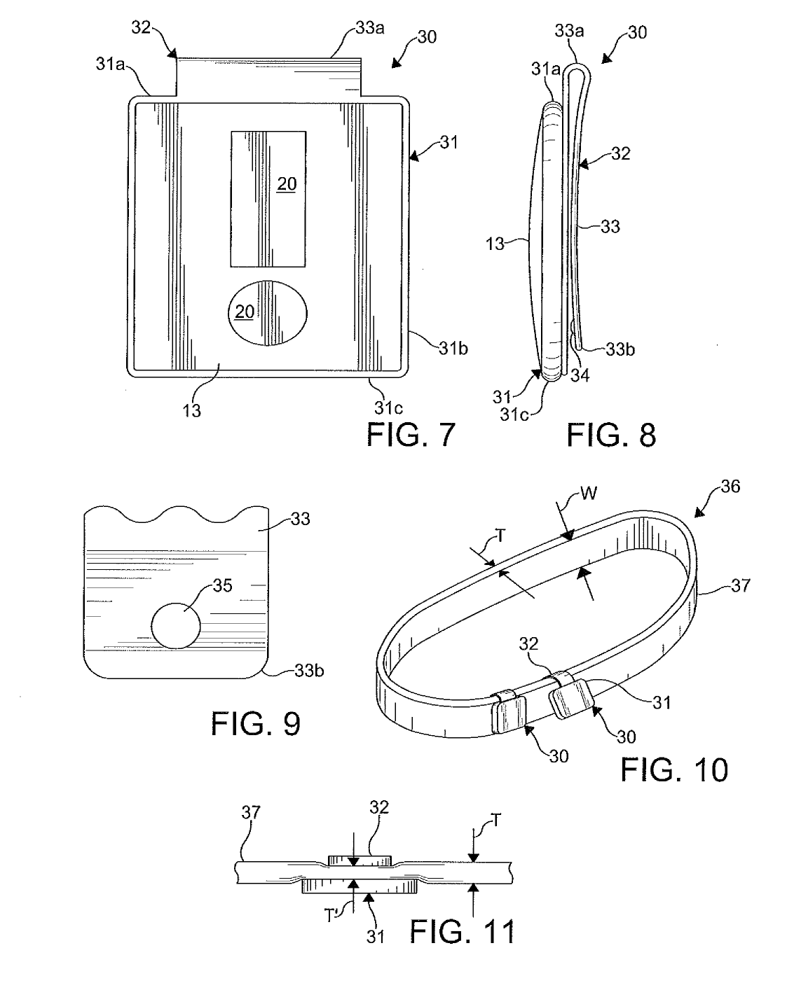

As shown in FIGS. 7 and 8, a message clip 30 has a body 31, similar to the body 11c shown in FIG. 4, with a clip portion 32 formed integral therewith such that the body 31 and the clip portion 32 are a one-piece unit. The message clip 30 includes the message portion 13 mounted in a recessed area at the front surface for displaying the message 20. The clip portion 32 extends from an upper periphery 31a of the outwardly extending flange 31b that forms a side wall of the recess. A leg 33 of the clip portion 32 extends at an angle to and is spaced from the rear surface of the body 31. The leg 33 has one end 33a that is U-shaped and connects to the upper periphery 31a of the body 31. The leg 33 then angles toward the body 31 and terminates in a free end 33b that curves away from the body 31 short of a lower periphery 31c.

The free end 33b of the leg 33 has a raised portion 34 extending toward the back surface of the body 31 as shown in FIG. 8. If the body 31 and the clip portion 32 are formed of a plastic material, the raised portion can be a molded feature. If the body 31 and the clip portion 32 are formed of a metal material, the raised portion 34 can be formed by displacing material in the free end 33b resulting in a corresponding depression 35 at the outer surface of the leg 33 as shown in FIG. 9.

The message clip 30 is intended to be used in a message display bracelet 36 as shown in FIG. 10. The bracelet 36 includes a continuous band 37 of flexible, elastic material. For example, the band 37 can be formed from a silicone material that is latex free. The band 37 has a generally rectangular cross section with a width W and a thickness T. The band 37 will stretch in diameter to slide over a hand of the user and then return to the unstretched diameter or larger to accommodate the user's wrist. The message clip 30 is shown removably attached to the band 37 by receiving the band between the rear surface of the body 31 and the clip portion 32. The height of the body 31 between the upper periphery 31a and the lower periphery 31c is approximately equal to the width W of the band 37. As shown in FIG. 11, the body 31 and the clip portion 32 slightly compress the band 37 to reduce the thickness from T to T′. This compression and gripping by the raised portion 34 removably secure the clip 30 to the band 37 for wearing the bracelet 36. Of course, more than one of the message clip 30 can be removably attached to the band 37 for displaying different messages.

In accordance with the provisions of the patent statutes, the invention has been described in what is considered to represent its preferred embodiment. However, it should be noted that the invention can be practiced otherwise than as specifically illustrated and described without departing from its spirit or scope.

What is claimed is:

1. A bracelet for displaying messages comprising:
a continuous band of flexible, elastic material for wearing on a wrist of a user, said band having a predetermined thickness;
a message clip body with a front surface, a rear surface and a flange extending about a periphery of said front surface forming a recessed area;
a clip portion connected to an upper periphery of said body for releasably holding said body on said band with said band retained between said clip portion and said rear surface of said body; and
a message portion having a display surface with a message displayed thereon, said message portion being mounted on said body and received in said recessed area wherein said message is visible.

2. The bracelet according to claim 1 wherein said band is formed of a silicone material.

3. The bracelet according to claim 2 wherein said silicone material is latex free.

4. The bracelet according to claim 1 wherein said body is formed of one of a metal material and a plastic material.

5. The bracelet according to claim 1 wherein said clip portion is formed integral with said body as a one-piece unit.

6. The bracelet according to claim 1 wherein said message portion is attached to said body by an adhesive material.

7. The bracelet according to claim 1 wherein said clip portion has a raised portion formed at a free end for gripping said band.

8. The bracelet according to claim 1 wherein said clip portion has a free end terminating before reaching a lower periphery of said body.

9. The bracelet according to claim 1 wherein said clip portion has curved end connected to said upper periphery of said body and an opposite free, said clip portion angling toward said rear surface of said body from said curved end to said free end.

10. The bracelet according to claim 1 wherein said clip portion and said body compress a portion of said band therebetween to a reduced thickness less than said predetermined thickness.

11. The bracelet according to claim 1 wherein said body has a height between said upper periphery and said lower periphery approximately equal to a width of said band.

12. A bracelet for displaying messages comprising:
a continuous band of latex free silicone material for wearing on a wrist of a user, said band having a predetermined thickness;
a message clip body with a front surface, a rear surface and a flange extending about a periphery of said front surface forming a recessed area;
a clip portion connected to an upper periphery of said body for releasably holding said body on said band with said band retained between said clip portion and said rear surface of said body, said body and said clip portion being formed as an integral, one-piece unit; and
a message portion having a display surface with a message displayed thereon, said message portion being mounted on said body and received in said recessed area wherein said message is visible.

13. A bracelet for displaying messages comprising:
a continuous band of flexible, elastic material for wearing on a wrist of a user, said band having a predetermined thickness;
a message clip body with a front surface, a rear surface and a flange extending about a periphery of said front surface forming a recessed area;
a clip portion connected to an upper periphery of said body for releasably holding said body on said band with said band retained between said clip portion and said rear surface of said body, said body and said clip portion being formed as an integral, one-piece unit wherein said clip portion and said body compress a portion of said band therebetween to a reduced thickness less than said predetermined thickness; and
a message portion having a display surface with a message displayed thereon, said message portion being mounted on said body and received in said recessed area wherein said message is visible.

14. The bracelet according to claim 13 wherein said band is formed of a silicone material.

15. The bracelet according to claim 14 wherein said silicone material is latex free.

16. The bracelet according to claim 13 wherein said body is formed of one of a metal material and a plastic material.

17. The bracelet according to claim 13 wherein said message portion is attached to said body by an adhesive material.

18. The bracelet according to claim 13 wherein said clip portion has a raised portion formed at a free end for gripping said band.

19. The bracelet according to claim 13 wherein said clip portion has curved end connected to said upper periphery of said body and an opposite free, said clip portion angling toward said rear surface of said body from said curved end to said free end.

20. The bracelet according to claim 13 wherein said body has a height between said upper periphery and said lower periphery approximately equal to a width of said band.
